(19) United States
(12) Patent Application Publication
(10) Pub. No.: US 2005/0035144 A1
(43) Pub. Date: Feb. 17, 2005

(54) System for monitoring and controlling access to reservoirs and a cover

(76) Inventor: Fabricio De Araujo Sacchi, Sao Paulo (BR)

Correspondence Address: TraskBritt, PO Box 2550, Salt Lake City, UT, 84110, US

(21) Appl. No.: 10/487,165

(22) PCT Filed: Aug. 13, 2002
(86) PCT No.: PCT/BR02/00112

(30) Foreign Application Priority Data
Aug. 16, 2001 (BR) PI 0103409-0

(51) Int. Cl. B67D 5/32

(52) U.S. Cl. 222/52; 702/51; 73/200; 222/26

(57) ABSTRACT

A system for monitoring and controlling access to reservoirs is described, which comprises: (i) a supervision system (10); (ii) at least one energy-distribution and communication system (20); and (iii) at least one cover (30), the energy-distribution and communication system (20) being associable with the supervision system (10) and with the cover (30), and the supervision system (10) being remotely associable with the energy-distribution system (20) Further, a reservoir cover (30) provided with a covering portion (302) and an articulation device (303), the covering (302) being associated with the articulation device (303), the cover (30) comprising an actuation device, a lock element (305) and a lock receiving element (304), the actuation device selectively actuating the lock element (305), which is selectively associated with the lock receiving element (304).

The present invention relates to a system for monitoring and controlling access to reservoirs, particularly those used at service stations, and to a cover developed to be monitored and controlled by the access monitoring and controlling system.

### DESCRIPTION OF THE PRIOR ART

Access to reservoirs that hold products harmful to the human being and to the environment, mainly underground reservoirs at service stations, should be precisely monitored, controlled and made available only to qualified persons.

However, art present it is known that control and safety locks of reservoirs are not capable of monitoring the access thereto, or else preventing, in a safe way, the access by unauthorised people.

In this regard, and in the case of a fuel reservoir, for example, the consumer is vulnerable to acquiring an adulterated product, of low quality, and suffer losses due to damages which such a product may cause to the vehicle. Another harmed party, in the case of an infringements is the fuel distributing company, the product of which is adulterated without its acknowledgement and authorisation.

For the fuel reservoir taken as an example, there are safety locks for the purpose of preventing its being infringed. These locks are associated to the cover existing at the nozzle that feeds the product to the reservoir, so as to prevent unauthorised people from open it. For this purpose, these safety locks are composed, in most part, of an electric lock actuated by an electronic device, which may be a switch or the like, and the cover is opened by hand, by means of tools such as a crank, a spindle, a handle, etc.

The disadvantage of these safety locks lies in the fact that it is not possible to monitor the reservoir covers in order to know when the latter are open or closed, and further to monitor, by means of stored data, how many times in a determined period the reservoirs were opened and how long they remained opened.

Another disadvantage of the safety systems used in fuel reservoirs and other reservoirs containing products harmful to the environment is the fact that these systems do not monitor possible leakage of the products held therein, for the purpose of preventing contamination of the environment and intoxication in the event of people coming into contact with such products.

Still in the event of a leakage, the owner of the establishment, the reservoir of which has had a leakage, might be punished by fine because of the damages caused to the environment, and his business might be closed down.

### OBJECTIVES OF THE INVENTION

The objective of the present invention is to provide a system for monitoring and controlling access to reservoirs, so as to enable one to follow up the moments of opening and closing them, as well as to control precisely the mechanisms used for opening and closing the monitored reservoirs.

Another objective of me present invention is to enable this monitoring to be affected remotely, in an environment that does not necessarily need to be the same environment in which the monitored reservoir is.

A further objective of this invention is to provide a cover provided with sensors and actuating commands, which, in conjunction with the access monitoring and controlling system, brings about precise safety in opening an closing access to the reservoirs.

### BRIEF DESCRIPTION OF THE INVENTION

The invention has the objective of providing a system for monitoring and controlling access to reservoirs, which comprises:
(i) a supervision system;
(ii) at least one energy-distribution and communication system; and
(iii) at least one cover,
   the enemy distribution system being associable with the supervision system and with the cover, and the supervision system being remotely associable with the energy-distribution and communication system.

A further objective of this invention is to provide a reservoir cover provided with a covering portion and an articulation device, the covering being associated with the articulation device and comprising an actuation device, a locking element and a lock-receiving element, the actuation device selectively actuating the locking element, which selectively is associated with the lock-receiving element.

### BRIEF DESCRIPTION OF THE DRAWINGS

The present invention will now be described in greater detail with reference to an embodiment represented in the drawings. The figures show:

FIG. 1: a block diagram of the system for monitoring and controlling access to reservoirs of the present invention;

FIG. 2: a block diagram of the supervision system that composes the monitoring system of the present invention:

FIG. 3: a block diagram of the energy-distribution and communication system;

FIG. 4: a schematic view of the utilisation of the cover that composes the system for monitoring and controlling of the present invention;

FIG. 5: a block diagram of the cover that composes the monitoring and controlling system of the present invention:

FIG. 6: a cross-section elevation view of the cover in closed condition;

FIG. 7: a top view of the cover in closed condition;

FIG. 8: a left side cross-section view of the cover in closed condition;

FIG. 9: a front view of the covering that composes the cover;

FIG. 10: a front view of the cover body;

FIG. 11: a lower view of the cover in closed condition; and

FIG. 12: a lower view of the cover in closed condition.

### DETAILED DESCRIPTION OF THE FIGURES

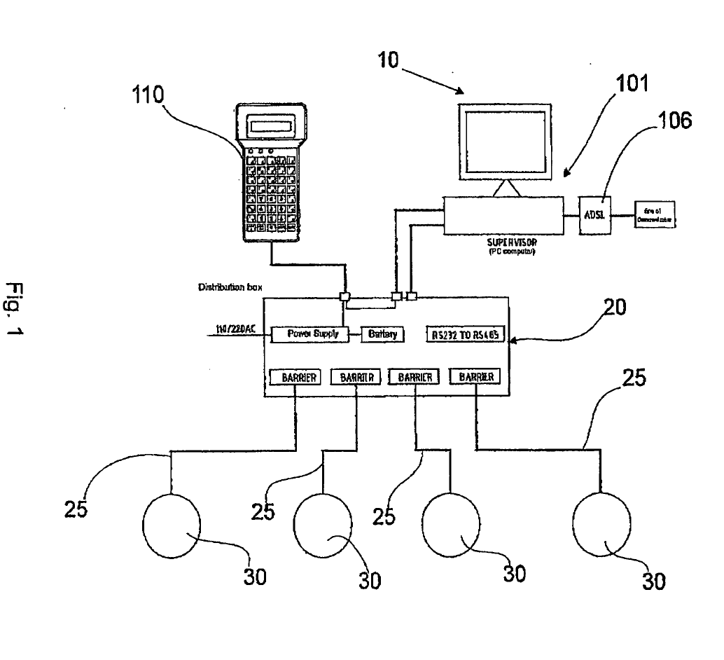

According to a preferred embodiment and as may be seen in FIG. 1, the present invention is a composition of a equipment that operate in conjunction, perform the function of monitoring and controlling access to reservoirs.

The system is composed of the following elements:
(i) a supervision system 10;
(ii) at least one energy-distribution and communication system 20; and
(iii) at least one cover 30.

These elements intercommunicate by mean of a local network.

The supervision system 10 is the element that manages all the elements belonging to the network controlling and monitoring all the information pertinent to the energy-distribution and communication system 20, to the covers 30, and to the measuring and leakage-detecting systems (not illustrated).

This system 10 is indispensable to the functioning of the other pieces of equipment that compose the control system of this invention.

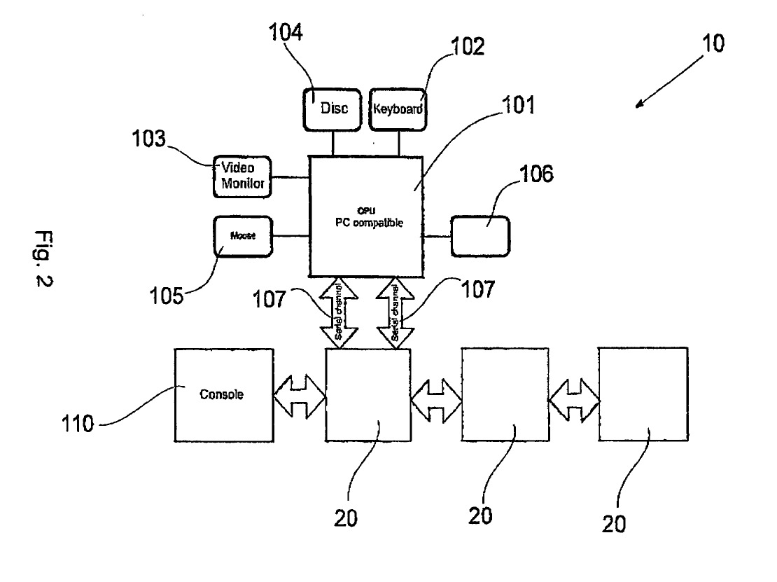

As illustrated in FIG. 2, the supervision system 10 comprises a first information-processing circuit 101 compatible with a PC-type computer, a data input device 102, for example a keyboard, a view finder 103, for example a video monitor, a data-exchange device 104, for example a disc drive or CD reader/recorder, a mouse 105 and a communication system 106, which may be a cable modem, that is to say, permanently ready for date transmission, or one of the type associable with a dialled line, which needs to be connected to a telephone line in order to initiate the data transmission. The communication device 106 may further be constituted by pieces of equipment having radio-frequency or optical fibre cables. This communication device 106 enables the supervision system 10 to communicate with other remote systems away from the environment of the system 10.

The first information processing-circuit 101 comprises a main control system, which may be a software, for example, the function of which is to store and process the programming routines necessary to the functioning of the components and of the access controlling system itself, beside storing and processing data received during the functioning of the system. This main control system uses a graphic interface and can monitor other devices that might be added to the system network.

The supervisions system 10 is installed remotely, that is, far away from the environment where the controlled reservoir is, and is connected to the energy-distribution and communication system 20 by means of serial channels 107.

Optionally, the supervision system 10 may comprise a remote console 110 associated with the energy-distribution and communication system 20. This console 110 is installed in areas closer to the controlled reservoir and has the function of making available functions and data of the system as a whole, whenever the supervisions system 10, which is the main system, is not accessible, for instance in loading and unloading operations at night near the reservoir.

However, it is up to the supervisions system 10 to report to the company that distributes product loaded/unloaded in the monitored and controlled reservoirs, to inform it of the existence of one or more covers 30 that are not closed, eventual leakage of product, the day and time of unloading the product into the reservoirs, the locking and unlocking of one or more covers 30 between others relevant pieces of information.

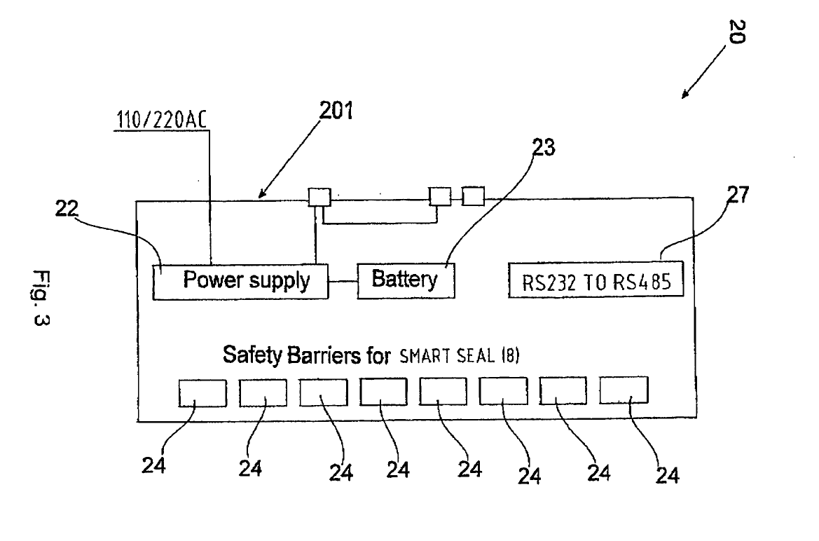

As may be seen in FIG. 3, the energy-distribution and communication system 20 accounts for the distribution of cables and supply of energy and communication date to all the other elements of the system, especially to the covers 30.

This energy-distribution system 20 comprises a distribution box 201, a power supply 22 associated with at least one battery 23 for cases of lack of energy, and a plurality of safety barriers 24 associated with the power supply 22, that is to say for each cable connected to the energy-distribution system 20 there is a safety barrier 24. The data communication signals of all the devices are joined in this distribution box 201.

The safety barrier 24 is composed of voltage-limiting Zener diodes and current-limiting resistors.

According to FIG. 1, at least one safety barrier 24 is associable with the cover 30 by means of the cable 25, and a plurality of safety barriers 24 of the distribution system are associable with a plurality of covers 30 by means of a plurality of cables 25. By means of these safety barriers 24, the energy-distribution system 20 individually supplies energy to the covers 30.

Communication cables go from the system 20 to the supervision system too.

The energy-distribution system 20 is constructed in a metallic box (not illustrated) containing a separate compartment for accommodating the safety barriers 24, where to field connectors are fixed, and the latter are thus called because they are present in risk areas (Classified Areas).

In addition to the safety barriers 24, the energy supply 22, the battery 23 and the converter block 27 are also arranged in the same metallic box.

The converter block 27 comprises an interface called RS-232, which is a serial communication standard involving a main (host) system called DTE (Data Terminal Equipment) and a peripheral system called DCE (Data Circuit-terminating Equipment). This interface RS-232 uses voltages that reach +12V and −12V to represent the logical levels. This communication standard is widely used and incorporates commercial computers as a compulsory item. It is used for connecting only two pieces of equipment per “port”. It is considered to be the standard communication for compatible PC's (personal computers).

The inverter block 27 further comprises an interface RS-485, which is a serial communication standard that enable up to 32 pieces of the so-called “Nodes” pieces of equipment to be interconnected by means of 2 or 4 wires. This interface RS-485 uses differential voltages lesser than 5, to represent the logical levels. This communication standard is used for communication with the covers 30.

Bering in mind the different characteristics presented by the two communication standards, there is a need to make the traffic of information between them compatible, so as to take advantage of their characteristics in each case.

Thus, in the face of its topology, the network RS-485 between the energy-distribution and communication system 20 and the covers 30 have an address associated with each node of the network. This allows all the nodes to “hear” the data that travel along the line and only “reply” thereto, if they are pertinent to their address. This require the answers from the covers 30 to be summed in order to return to the Host RS-232.

Another characteristic of the RS-485 is the presence of carrier Enabling, when a node becomes active in the line, sending data. The control of these carriers is effected in the distribution system 20, within the converter block 27, by means of a microcontroller actuating on the RS-485 drivers that are arranged so as to precede the safety barrier 24 associated with the covers 30.

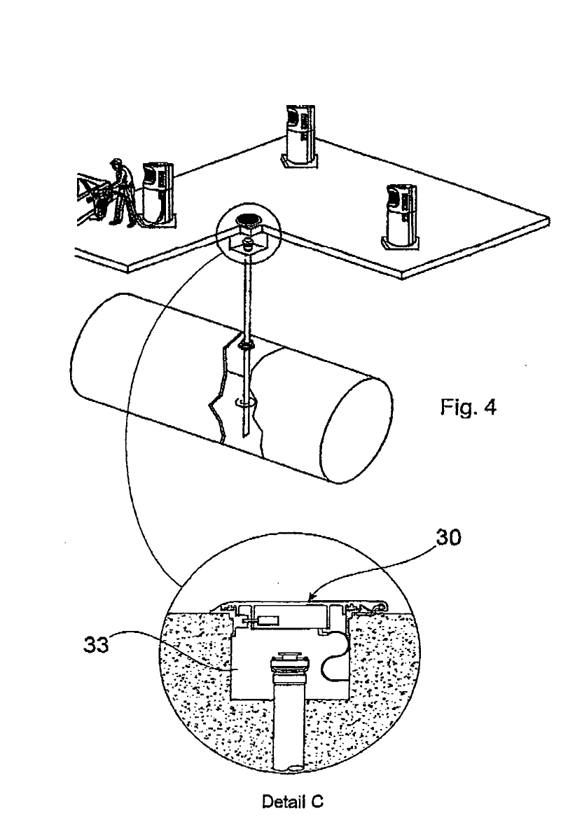

As illustrated in FIG. 4, the cover 30 is installed at the points of access to the reservoir (unload, suction and measurement), close to the holding chamber 33.

This holding chamber 33 stores the liquid that leaks out of the reservoir when the latter is supplied, in order to prevent contamination of the environment in which the reservoir is.

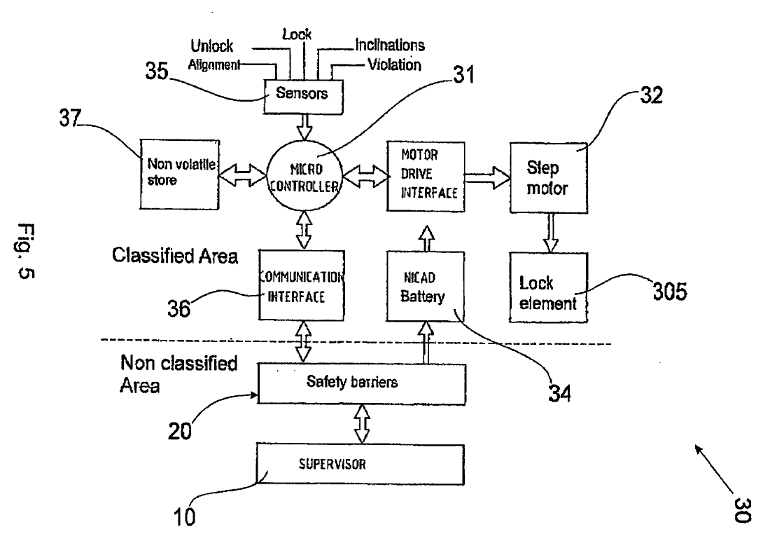

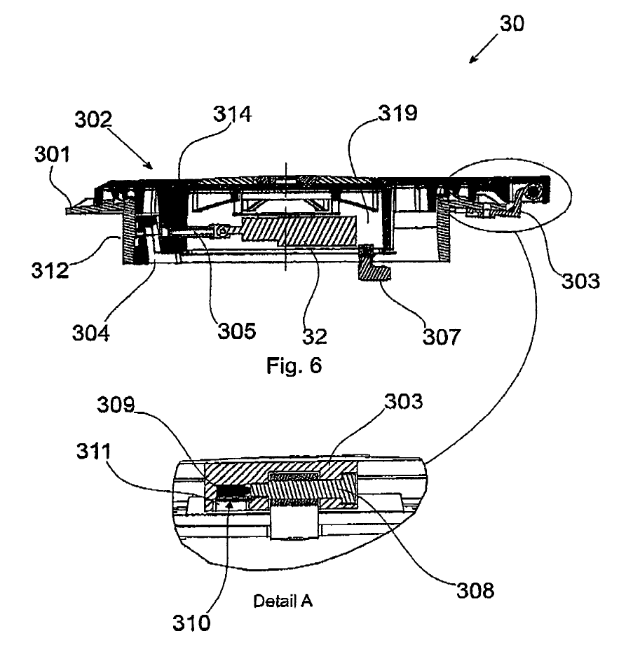

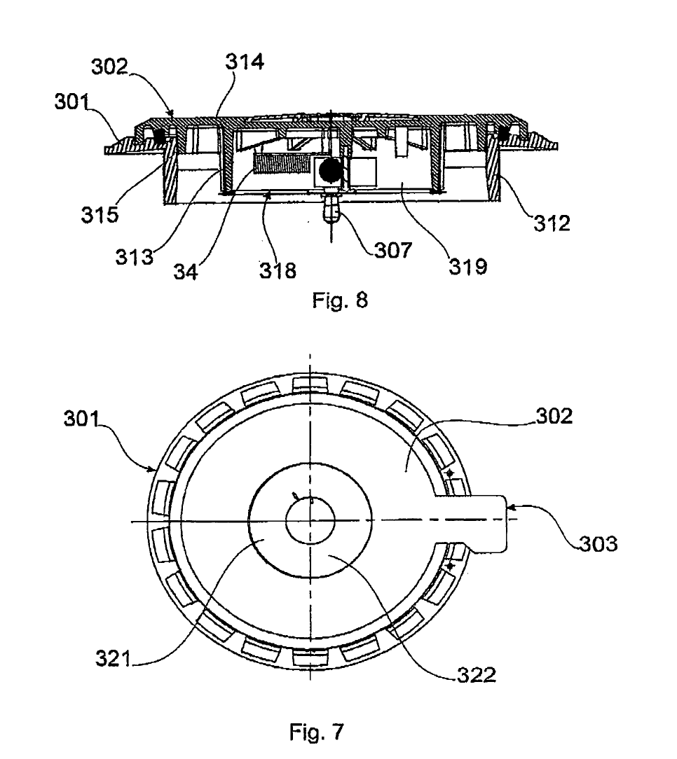

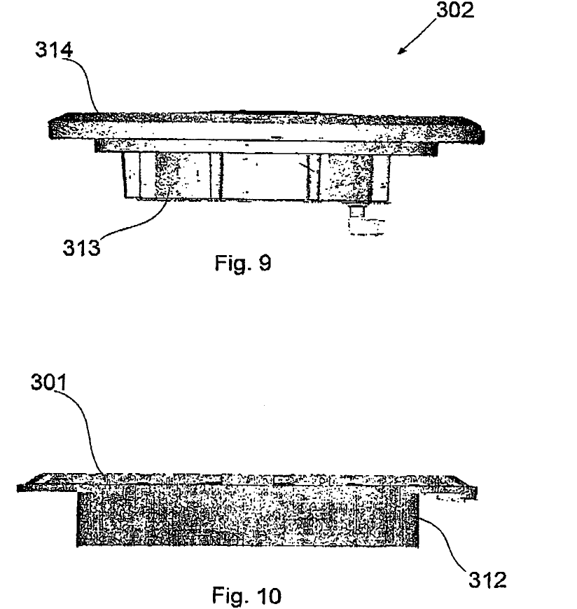

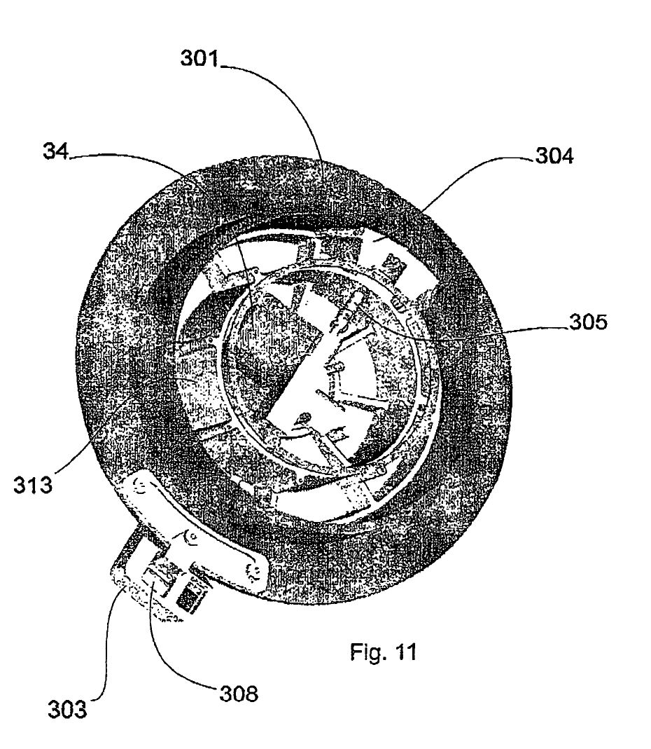

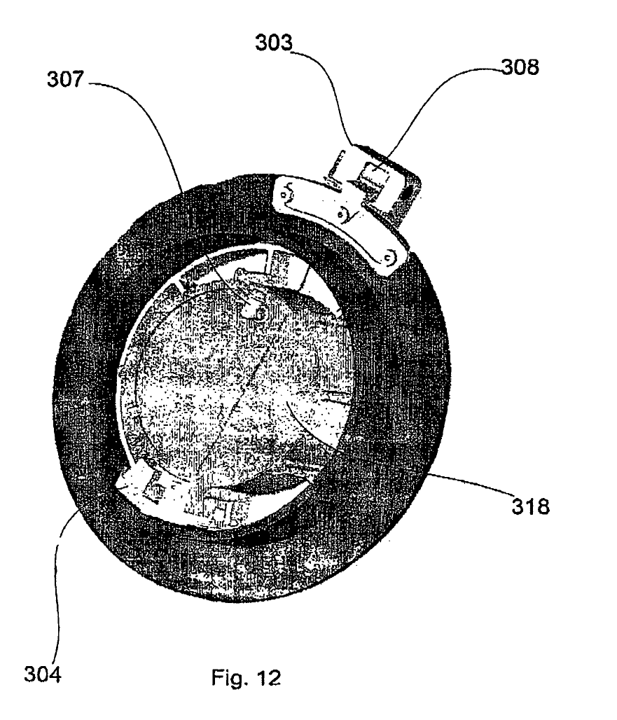

As illustrated in FIGS. 5-11, the cover 30 is physically provided with a covering portion 302 and an articulation device 303.

The covering 302 is the main element of the cover 30, being made of molten aluminum with low copper and magnesium contents. It is cylindrical in shape, comprises a base 314, a first cylindrical projection 313 that is substantially perpendicular to the base 314, and a second cylindrical projection 315 that is substantially perpendicular to the base 314 and may be associated with the holding chamber 33. The function of the covering 302 is to close the reservoir. All the components of the cover 30 is mounted thereon, except for the lock receiving element 304, which is mounted close to the holding chamber 33.

The first cylindrical projection 313 comprises a first end 316 attached to the base 314 and a second end 317 opposite the first end 316. A plate 318 is associated with the second end 317 of the first cylindrical projection 313, so as to form a hermitic compartment 319. The plate 318 is metallic and provided with a diameter equivalent to the diameter formed by the first cylindrical projection 313.

The hermetic compartment 319 has, at the portion close to the base 314 of the covering 302, a sealing rubber fixed by means of screws that are evenly distributed.

The articulation device 303 is made of molten steel and allows the covering 302 to tilt, for example up to 110° from the opening. This articulation device 303 comprises a pin 308, a sensor 309 and a fitting 310. The sensor 309 is axially associated with the pin 308 and arranged in a recess portion 311 of the articulation device 303. The fitting 310 is positioned in the recess portion 311, below the sensor 309. The pin 308 may be removed for emergency opening and has a threaded portion to facilitate its removal.

A first identification label 321 is located on the upper outer portion of the covering 302. It is manufactured from plastic and may have the colour and the trademark of the distributing company, in addition to other sayings that meet the Code of Consumer Defence.

A second identification label 322 is located at the central portion of the first identification label 321. The second label 322 may contain sayings that clearly identify the kind of product unloaded into the reservoir, beside having a colour code to help in this identification.

Close to the covering 302, in the hermetic compartment 319, the cover 30 comprises an actuation device, a lock receiving element 304 and a lock element 305. The actuation element selectively actuates the lock element 305, which is selectively associated with the lock receiving element 304.

The actuation device comprises a second information-processing circuit 31, electronic circuits, a step motor 32, and at least one communication interface 36.

The lock receiving element 304 is made of molten aluminium with low copper and magnesium contents, constituting a conical recess for guiding the shoulder (not illustrated) of the covering 302 and a receptacle (not illustrated) into which the lock element 305 fits.

The lock element 305 is made of non-magnetic molten stainless steel and has a locking-confirmation sensor. Where this element 305 passes there is a guiding conical recess (not illustrated), the function of which is to guarantee the alignment of the covering 302 with the lock receiving element 304.

The function of the lock element 305 is to lock the covering 302 on the lock receiving element 304, when the covering 302 is in the closed position. The element 305 is moved by the actuation device and has been designed for bearing strains to the effect of maintaining the covering 302 duly lacked.

If the reservoir already has a holding chamber 33, the articulation device 303 is associated with the chamber 33 by means of rivets or other fixing means and further associated with the covering 302 by means of the pin 308. In this case, the lock receiving element 301 is fixed close to the holding chamber 33 by means of rivets or other facing means.

When the reservoir does not have a holding chamber, the cover 30 comprises a body 301, the covering 302 and the articulation device 303. In this way, a holding chamber 33 is provided close to the cover 30, the fatter being fixed close to the body 301.

The body 301 is cylindrical, hollow and comprises a projection 312 that is substantially opposed to the covering 302.

Just as the covering 302, the body 301 may have various other shapes in addition to the cylindrical one, varying according to the need of the reservoir.

When the cover 30 comprises the body 301, the association of the covering 302 with the articulation device 303 continues to be effected by means of the pin 308, while the association of the articulation device 303 with the body 301 is effected by means of rivets or other fixing means. In this way, the lock receiving element 304 is fixed close to the body 301 of the holding chamber 33.

By moans of the step motor 32 and a reduction box system (not illustrated), the rotation movements are changed into a linear driving of the lock element 305.

There is a lock controller (not illustrated) having control electronic circuits that send pulses and commands for direct and reverse controlled actuation of the motor 32, which corresponds to the movement of the lock element 305 in the unlocked-cover and locked-cover positions.

The send information-processing circuit 31 transmits processed data to the electronic circuits, the electronic circuits are associated with the step motor 32 and so, the former control the functioning of th later. The step motor 32 actuates the opening and closing of the lock element 305.

At least one communication interface 36 is associable with the supervision system 10 and with the energy-distribution and communication system 20.

Further to compose the cover 30, there is at least one battery 34 and a cable connector 307. The battery 34 is associable with the energy-distribution system 20 and is constantly charged by this system 20 with a current of approximately 50 mA by means of the cable 25 associated with the cable connector 307.

The battery 34 feeds the electronic circuits and brings about the actuation of the lock element 305. It is rechargeable and composed of cells made of NiCd, Lithium, Lithium-ion, etc., encapsulated in a single block containing a current-limiting resistor.

The cover 30 is entirely associated in its main points; so the cover 30 comprises a plurality of sensors 35 and a data-storing device 37 associated with the second information-processing circuit 31.

The sensors assigned to the cover 30 are of the reed-switches, microswitches and tilt-switches type. The reed-switches sensors are position sensors, while the tilt-switches sensors are sensitive to inclinations or unlevelling of the cover 30.

The cable connector 307 comprises a (male) receptacle that is attached to the plate 318 of the hermetic compartment 319. In this way, the cable to be connected should have, at an end, a (female) sealed and watertight plug shaped at an angle of 90 degree.

By means of the connector 307, one effects the connection between the cover 30 and the energy-distribution system 20, beside facilitating the replacement of the cover 30 when it has a defect.

The cover 30 has a second information-processing circuit for local treatment of the conditions obtained by its sensors.

All the operations that take place with the cover 30, such as: opening, closing, unlocking, locking, communication failure, low battery, remaining open for along time, etc., are stored in the local data-storing device 37, independently of the operational state of the supervision system 10.

The history of this information basically bears the date and time of the event that has occurred, the device number (relative “address” of the cover) and the event code that informs about the situation that has taken place. This history is recorded in a cyclic way, that is, the last more recent events will always be stored, without the possibility of lack of space in the data-storing device 37.

In addition to the treatment of these operation recordings, the cover 30 can perform some autonomous functions, independently of command from the supervision system 10, that is, the second processing circuit 31 of the cover 30 is also provided with a secondary control system, which may be a secondary software, for example, which commands the autonomous function routines that are performed independently of the existence of the supervision system 10.

Some autonomous functions that are periodically performed by he cover 30 are:
Automatic locking of time course; for a cover 30 that has been unlocked the time of inactivity of this over 30 is counted. Wen a determined previously programmed time is exceeded, the cover is automatically locked.
Immediate automatic locking: the cover 30 locks automatically with the mere closing of the covering 302. This state is a parameter available in the system, which may be enabled or not.
Local diagnosis: the cover 30 analyses the behaviour of its sensors, detecting abnormal situations and evaluating the sate of the actuators. In this way, locking and unlocking operations are carried out, in order to diagnose the actual functioning of the system. In addition, the state of charge of the batteries 34 is continuously appraised, and all the conditions are reported to the supervision system 10.
Monitoring the cover-opening time: the cover 30, upon detecting the opening, also receives a maximum time in which it may remain open. In this case, the cover 30 counts this time, marking it in its internal registers, if the time is exceeded.
Automatic unlocking by low energy: the cover 30, upon detecting the low state of its batteries 34, effects an automatic unlocking, in order to enable one to make an easy maintenance of its components. This automatic unlocking is also registered in the history of operations of the cover 30.

The functions described above may also be performed by means of commands from the supervision system 10.

In addition to these functions, some points and specific positions of the cover 30 are sensed namely: the pin 308 of the articulation device 303, the alignment, the locking, the unlocking and the opening of the covering 302.

At the pin 308 of the articulation device 303, the sensing is effected by means of an immersion-proof sensor 309, installed at the end of the pin 308. In the event of undue removal of this pin 308 (tampering with), a signal is detected and immediately reported to the supervision system 10. Moreover, this situation remains internally recorded, in the event of a failure of communication with the supervision system 10.

The sensing of the alignment is effected by means of positioning sensor of the reed-switch type, installed on the lock element guide of the covering 302. It enables one to verify which cover 30 is correctly positioned and in locking conditions.

In the event of a failure in the alignment, the supervision system 10 will consider the cover that is incorrectly closed.

The sensing of the locking is effected by means of another read-switch type sensor, installed at the end of the lock element 305, so as to check the fitting of the latter into the lock receiving element 30. In the event of a failure, the supervision system 10 will not consider the cover 30 that is correctly locked.

The sensing of the opening is effected by means of a tilt-switch-type levelling switch, which is fixed to an electronic-circuit plate. This sensing verifies if the cover is in the opened position, that is, out of the pre-established levelling.

All the information monitored locally is sent to the supervision system 10, which is always maintained updated, including with recordings relating to the operation of opening and closing, alarms, tampering with, etc.

A preferred embodiment having been described, one should understand that the scope of the present invention embraces other possible variations, being limited only by the contents of the accompanying claims, which include the possible equivalents.

1. A system for monitoring and controlling access to reservoirs, comprising:
(i) a supervision system;
(ii) at least one energy-distribution and communication system; and
(iii) at least one cover actuated by the supervision system through the energy-distribution and communication system,
wherein the supervision system is positioned remotely from the reservoirs, the supervision system comprising a first information-processing circuit associated to at least one energy-distribution and communication system and to at least one cover, the cover comprising a covering portion that comprises an hermetic compartment where a lock element actuated by a step motor and a plurality of monitoring and controlling sensors are mounted.

2. The system according to claim 1, wherein the covering portion comprises an articulation device containing a pin and a sensor, the sensor being axially associated to the pin.

3. The system according to claim 2, wherein the covering portion is bascule moved by means of the articulation device.

4. The system according to claim 1, wherein the cover comprises a second information-processing circuit associated to the step motor and controlling the step motor rotation.

5. The system according to claim 4, wherein the step motor rotation is transformed into the lock element linear movements, said linear movements being locking and unlocking movements.

6. The system according to claim 4, wherein the monitoring and controlling sensors are controlled by the second information-processing circuit, the second information-processing circuit comprising a secondary control system with routines.

7. The system according to claim 6, wherein the cover comprises at least one battery associated to the step motor and a data-storing device associated to the second information-processing circuit.

8. The system according to claim 1, wherein the cover comprises at least one communication interface simultaneously connected to the supervision system and the energy-distribution and communication system.

9. The system according to claim 1, wherein the supervision system comprises a data-input device associated to a view finder and to the energy-distribution and communication system by the first information-processing circuit.

10. The system according to claim 9, wherein the supervision system comprises a main control system associated to the first information-processing circuit, the main control system having routines.

11. The system according to claim 10, wherein the supervision system stores information and data processed by the first information-processing circuit by means of a data-exchange device.

12. The system according to claim 11, wherein the supervision system comprises a communication device associated to the first information-processing circuit, the communication device transmitting data to distinct remote systems.

13. The system according to claim 1, wherein the supervision system comprises a remote console associated to the energy-distribution and communication system.

14. The system according to claim 1, wherein the energy-distribution and communication system comprises at least one battery and a plurality of safety barriers associated to an energy supply.

15. The system according to claim 14, wherein the energy-distribution and communication system is associated to the supervision system by means of at least one serial channel.

16. The system according to claim 15, wherein at least one cover is associated to at least one safety barrier of the energy-distribution and communication system by means of a cable.

17. The system according to claim 16, wherein the safety barrier comprises voltage-limiting diodes and current-limiting resistors.

18. A cover for reservoirs, wherein comprises a covering portion containing an hermetic compartment where a lock element actuated by a step motor and a plurality of monitoring and controlling sensors are mounted to monitor and control the covering portion.

19. The cover according to claim 18, wherein the hermetic compartment is positioned in a base of the covering portion, this hermetic compartments being composed by a first projection perpendicular to the based, the first projection containing a first end fixed to the base and a second end opposite the first end and associated to a plate.

20. The cover according to claim 19, wherein the plated is metallic and comprises a cable connector.

21. The cover according to claim 18, wherein the covering portion comprises an articulation device containing a pin and a sensor, the sensor being axially associated to the pin.

22. The cover according to claim 21, wherein the covering portion is bascule moved by means of the articulation device.

23. The cover according to claim 22, wherein the articulation device is associated to a holding chamber of the reservoirs.

24. The cover according to claim 18, wherein comprises a second information-processing circuit associated to the step motor and controlling the step motor rotation.

25. The cover according to claim 24, wherein that the step motor rotation is transformed into the lock element linear movements, said linear movements being locking and unlocking movements.

26. The cover according to claim 25, wherein by locking of the covering portion the lock element is associated to a lock receiving element disposed closer to the hermetic compartment.

27. The cover according to claim 24, wherein the monitoring and controlling sensors are controlled by the second information-processing circuit, the second information-processing circuit comprising a secondary control system with routines.

28. The cover according to claim 18, wherein the cover comprises at least one battery associated to the step motor and a data-storing device associated to the second information-processing circuit.
